(19) United States
(12) Patent Application Publication
(10) Pub. No.: US 2005/0250661 A1
(43) Pub. Date: Nov. 10, 2005

(54) Cleaning composition and cleaning of vehicles

(75) Inventor: Siegfried Bragulla, Monheim (DE)

Correspondence Address: Anneliese M Seifert;Ecolab Inc, Research & Development Center, 840 Sibley Memorial Highway, Mendota Heights, MN, 55118, US

(73) Assignee: Ecolab Inc., St. Paul, MN (US)

(21) Appl. No.: 10/526,793

(22) PCT Filed: Aug. 16, 2003
(86) PCT No.: PCT/EP03/09086

§ 371 Date: Apr. 11, 2005

(30) Foreign Application Priority Data
Sep. 10, 2002 (DE) 10241878.0

(51) Int. Cl. C11D 1/00

(52) U.S. Cl. 510/189

(57) ABSTRACT

Vehicle cleaning compositions containing one or more selected components with complexing properties, the use thereof for removing firmly adhering metal dust-containing and/or abraded metal-containing residues and for cleaning wheel rims, the production of corresponding vehicle cleaning solutions and a method for cleaning vehicles which is particularly protective of the surface.

The invention relates to vehicle cleaning compositions containing one or more selected components with complexing properties, to the use thereof for removing firmly adhering metal dust-containing and/or abraded metal-containing residues and for cleaning wheel rims, to the production of corresponding vehicle cleaning solutions and to a method of cleaning vehicles which is particularly protective of the surface.

Various things should be noted when cleaning vehicle surfaces. On the one hand, the surfaces may consist of a wide variety of materials. These surfaces may be produced, for example, from glass, rubber, coated surfaces, steel and aluminum, plastics materials, composites, thermoplastic polymer fabrics or from thermoplastic polymer fibers, plastic lenses or a large number of glass or metal composites.

However, many different types of soiling may also occur. This soiling may originate, for example, from fuels, lubricants, hydraulic and other operating fluids, dirt, components of the vehicle exhaust, residues of previously used detergents, waxes and the like. Firmly adhering residues containing metal dust and/or abraded metal are particularly difficult to remove.

Soiled vehicle surfaces have been cleaned for years using a large number of compositions and methods. These compositions may be simple solutions of organic dishwashing detergents or conventional multi-purpose detergents. When cleaning vehicles in trade or industry, for example during the semiautomatic and fully automatic washing of cars, a large number of detergents have been used for cleaning systems, the cleaning systems often involving a prewash cycle or precleaning cycle, a cleaning cycle and then a combination of one or more operations involving wax, detergent, rust-proofing agent, mechanical drying and the like. This type of vehicle cleaning may be the commercial cleaning of vehicles during which the vehicles are washed by the owner himself or by employees. The cleaning stations may be, for example, stations which are operated by car rental firms, car dealers, the operators of car fleets, in bus and railway depots, in aircraft servicing buildings and the like.

One category of generally available detergents contains a number of anionic surfactants which are used together with compatible nonionic surfactants, complexing agents, waxes and other components.

The prior art vehicle detergent is suitable for removing most residues.

In the vehicle industry, however, there are combinations of dirt which contain, for example, grease, carbon black and abraded metal which, after thorough cleaning with detergents which have a high surfactant content and readily dissolve grease, leave a thin, firmly adhering dust film consisting of abraded metal, in particular from brake linings of cars, railways vehicles or the like.

In the past, this dust could only be cleaned with highly alkaline or strongly acidic detergents, while employing, for example, high pressure or brushes.

However, the use of these detergents adversely affects the surfaces to be cleaned. Strong alkaline solutions and acids may markedly attack the coating on surfaces, for example on car wheel rims and bodies, and the coating on railway carriages. The coated surfaces of car wheel rims or railway carriages or other vehicles which have been cleaned several times in this way soon have a matt appearance and therefore lose the appearance of an as new vehicle.

It is therefore desirable to have further suitable alternatives for vehicle cleaning, in particular with respect to improved material compatibility and ability to remove difficult-to-remove residues such as metal dust and abraded metal.

The object of the present invention was accordingly to provide vehicle cleaning compositions which have good material compatibility and are capable of removing difficult-to-remove residues such as metal dust and abraded metal.

This object is achieved by a vehicle cleaning composition containing one or more components with complexing properties selected from the groups comprising polyamino and polycarboxylic acids and the salts thereof.

Suitable polycarboxylic acids include, for example, polyacrylic acids and copolymers of maleic acid anhydride and acrylic acid and the sodium salts of these polymeric acids. Conventional commercial products include Sokalan® CP 5 and PA 30 from BASF, Alcosperse® 175 and 177 from Alco, LMW® 45 N and SPO2 ND from Norsohaas. Suitable natural polymers include, for example, oxidized starch (e.g. DE 42 28 786) and polyamino acids such as polyglutamic acid or polyaspartic acid, for example from Cygnus, Bayer, Rohm & Haas, Rhône-Poulenc or SRCHEM.

The aforementioned components with complexing properties are particularly preferably selected from polyaspartic acid and/or copolymers based on aspartic acid.

It is also preferred if the vehicle cleaning composition according to the invention contains gluconic acid as an additional component with complexing properties. The vehicle cleaning compositions according to the invention may also contain a large number of other materials which are useful in the production of agents for cleaning vehicles and for water removal, such as nonionic surfactants, amine oxide surfactants, further complexing agents, acidic materials, basic materials, solvents and a large number of other useful materials such as colorants, perfumes, thickeners, foaming surfactants, etc.

Conventional hardening or solidifying agents such as urea, PEG materials, nonionic surfactants and the like may also be used. It is preferable if the vehicle cleaning composition according to the invention additionally contains a nonionic surfactant which is particularly preferably selected from the group comprising alkoxylated fatty alcohols which are optionally terminated by end groups and/or alkyl polyglycosides and/or alkoxylated fatty amines.

Suitable alkoxylated fatty alcohols include C₈₋₁₈ alkyl polyethylene glycol polypropylene glycol ethers with up to 8 mol ethylene oxide (=EO) and propylene oxide (=PO) units in the molecule respectively. The addition of tallow alcohol ethoxylated with 30 EO groups and the addition of oleylcetyl alcohol ethoxylated with 5 EO groups has also had a positive influence on the cleaning result. However, other known nonionic surfactants may also be used, such as C₁₂₋₁₈ alkyl polyethylene glycol polybutylene glycol ethers with up to 8 mol ethylene oxide and butylene oxide units in the molecule respectively, as well as alkyl polyalkylene glycol mixed ethers terminated by end groups. Suitable alkoxylated fatty amines include, for example, C₈₋₁₈ alkyl amines ethoxylated with 8 to 16 EO groups.

A further important nonionic surfactant can comprise an amine oxide. Representative examples of such amine oxides include lauryldimethyl amine oxide, dodecyldimethyl amine oxide, tetradecyldimethyl amine oxide, cetyldimethyl amine oxide, stearyldimethyl amine oxide, dodecyldiethyl amine oxide, bis(2-hydroxypropyl) tetradecyl amine oxide and the like.

The pH of the vehicle cleaning composition according to the invention preferably ranges from 4 to 10, particularly preferably from 5 to 9 and more particularly preferably from 6 to 8.

Preferred embodiments of the vehicle cleaning composition according to the invention contain 0.1 to 75% by weight, particularly preferably 0.5 to 50% by weight of the aforementioned complexing agents contained according to the invention, based on the total weight of vehicle cleaning composition.

Particularly preferred embodiments of the vehicle cleaning composition according to the invention contain 0.1 to 30% by weight of polyaspartic acid, more particularly preferably in combination with 0.1 to 50% by weight of gluconic acid, based on the total weight of vehicle cleaning composition.

The present invention also relates to the use of vehicle cleaning compositions according to the invention for the cleaning of vehicle surfaces, in particular for the removal of metal dust-containing and/or abraded metal-containing residues adhering firmly to vehicle surfaces. The use according to the invention is particularly preferred if the residues consist of iron oxide or at least contain iron oxide fractions.

Surfaces include, in particular, vehicle wheel rims and any other surfaces mentioned in the description of this application, such as coated surfaces and the like.

For the purposes of this description, the term “vehicle” refers to any means of transport, including cars, lorries, sports/utility vehicles, buses, golf buggies, motor cycles, monorail vehicles, diesel engines, long-distance coaches, small single-engine private aircraft, airline jet planes, conventional commercial airline equipment and the like.

With the use according to the invention, the removal of metal dust-containing and/or abraded metal-containing residues adhering firmly to vehicle surfaces is preferably carried out in a separate cleaning stage detached from the conventional cleaning of vehicles, before or after the conventionally performed cleaning of the vehicles to be cleaned.

The present invention also relates to the production of vehicle cleaning solutions by dilution of a vehicle cleaning composition according to the invention with water, so that the ready-to-use cleaning solution contains 0.025 to 100 g/l, preferably up to 50 g/l of at least one of the aforementioned components with complexing properties and, in a particularly preferred embodiment, additionally contains 0.05 to 50 g/l, more particularly preferably 0.5 to 5 g/l of the aforementioned nonionic surfactant.

The present invention also relates to vehicle cleaning solutions according to the invention produced by mixing a solution containing at least one of the aforementioned components having complexing properties with a solution containing the aforementioned nonionic surfactant, a ready-to-use cleaning solution containing 0.025 to 100 g/l, preferably 50 g/l, of at least one of the aforementioned components with complexing properties and additionally 0.05 to 50 g/l, more particularly preferably 0.5 to 5 g/l, of the aforementioned nonionic surfactant being obtained, optionally after further dilution.

Finally, the present invention also relates to a method for cleaning a vehicle which is particularly protective of the surface and in which a vehicle cleaning solution according to the invention is applied to the surface of the vehicle and is rinsed off with water after the cleaning operation.

The vehicle cleaning compositions according to the invention are preferably used in systems which operate with brushes or by contact with cloth or without contact. Contactless systems usually operate by merely spraying the aqueous systems, followed by rinsing with water which leaves a cleaner vehicle surface containing small amounts or no residues of the cleaning composition or the detergent.

The vehicle cleaning compositions according to the invention are typically applied to a vehicle surface to remove many types of soiling which usually occurs during transportation, during transfer by rail, at airports and on motorways and the like.

The term “contactless cleaning system” denotes a method with which the detergents are brought into direct contact with a vehicle surface, including coated surfaces, surfaces made of thermoplastic laminate, glass surfaces, plastic surfaces or surfaces comprising conventional car trims, in order to remove soil by spraying or washing without a mechanical action being employed during the removal of dirt. In use, an aqueous cleaning composition has to remain in contact with these surfaces for a relatively short time (shorter than 5 minutes) in order to assist dirt removal. The aqueous systems are typically removed from the vehicle surface by rinsing with water and then with a water removing agent.

The vehicle cleaning compositions according to the invention may generally be applied in liquid, solid, pasty or other forms.

The vehicle cleaning compositions according to the invention may contain acidic or basic substances as further ingredients, with which a basic or acidic pH may be neutralized. These basic substances include, for example, amines, sodium hydroxide, sodium silicates and the like. These materials may act as alkaline builders, dirt carriers and as buffers. The preferred silicates may also act as protection for aluminum by reducing the effects of the chemicals according to the invention on exposed aluminum surfaces. The alkaline builders should be present in sufficient large amounts for achieving a substantially neutral pH (for example about 6 to 10, preferably 6 to 9). A large number of typical weak or mild acids may be used to neutralize and solubilize the basic compositions to different pH values. These acids include, for example, acetic acid, hydroxyacetic acid, phosphoric acid, citric acid and other typical acids which are used to produce cleaning compositions.

The vehicle cleaning compositions according to the invention may contain a solvent. The preferred chemistry requires no solvent. Preferred solvents include alcohols, glycols and glycol ethers. These substances generally have an aliphatic fraction containing 2 to 6 carbon atoms. Examples of these substances include ethanol, propanol, isopropanol, butanol, 2-butanol, 2-methyl-2-propanol, butoxydiglycol, ethoxydiglycol, polypropyleneglycol, ethyleneglycol methylether, ethyleneglycol dimethylether, propyleneglycol methylether, dipropyleneglycol-n-butylether, butoxyethanol, phenoxyethanol, methoxypropanol, propyleneglycol, n-butylether, tripropyleneglycol, n-butylether, propyleneglycol, hexyleneglycol and other similar oxygen-containing solvents.

### EXAMPLES

The following test was carried out in order to discover the effectiveness of different detergent formulations against soiling which is typical of the aforementioned applications:

Some stainless steel panels (5×10 cm) were prepared for the test by applying 0.4 to 0.5 g of standard dirt to one side of the test panel and then leaving it to dry for 24 hours at 25° C. Car brake dust combined with mineral oil dirt (1), on the one hand, and railway brake dust combined with iron oxide dirt (2), on the other hand, were used as standard dirt.

The cleaning test was carried out by immersing the test objects pretreated in this way into the various cleaning solutions at temperatures of 20° C. for 20 minutes in a fully automatic immersion apparatus. The detachment of the covering was determined gravimetrically.

The formulations shown in the following table were converted, by dilution with water to service concentrations, into a cleaning solution of which the cleaning capacity was determined in the test.

TABLE 1
Cleaning capacity of formulations of different compositions (details in
% by weight) with respect to soil conventionally encountered in the
engineering industry

| | Examples/active ingredient content in wt. % | | | | | | |
|---|---|---|---|---|---|---|---|
| Ingredients | Comp. 1 | Comp. 2 | Comp. 3 | Comp. 4 | Ex. 1 | Ex. 2 | Ex. 3 |
| Citric acid | 0 | 20 | | 50 | | 5 | |
| NaOH (50%) | 25 | 0 | 25 | 0 | 2 | 0 | 0 |
| NTA | 20 | 0 | 0 | 0 | 4 | 0 | 0 |
| EDTA | 0 | 20 | 20 | 0 | 0 | 2 | 0 |
| Gluconic acid | 0 | 0 | 0 | 0 | 10 | 25 | 25 |
| Hydroxyethane | 2.5 | 2.5 | 2.5 | 2.5 | 2.5 | 2.5 | 2.5 |
| diphosphonate | | | | | | | |
| (Na salt) | | | | | | | |
| Polyaspartic acid | 0 | 0 | 0 | 0 | 10 | 20 | 20 |
| C₁₂₋₁₈ fatty alcohol 9 EO | | | | 16.5 | | | |
| Butyl ether | | | | | | | |
| C₁₂₋₁₈ fatty alcohol 5 EO + 4 | 15 | 15 | 15 | | 15 | 15 | 15 |
| PO | | | | | | | |
| Coconut amine 12 EO | 0 | 0 | 0 | 16.5 | 0 | 5 | 5 |
| Alkyl glycoside | 2 | 1 | 2 | 0 | 5 | 0 | 0 |
| Remainder to 100% | Demineralized water | | | | | | |
| SW concentration (%) | 4 | 4 | 4 | 4 | 4 | 4 | 4 |
| Soil removal | | | | | | | |
| Test soil (1) | 11.3 | 1.5 | 11.8 | 16.4 | 78 | 98.5 | 98.7 |
| Test soil (2) | 12.6 | 2.8 | 12.6 | 19.3 | 89 | 99.6 | 99.6 |

Comp. 1 to 4 = comparison examples
Ex. 1 to 3 = examples according to the invention

The material compatibility was also investigated using the formulations listed in Table 1. On the one hand, the material compatibility was investigated on stainless steel test panels (5×10 cm) coated with polyacrylate resin coatings conventional in the vehicle industry. On the other hand, the tests were carried out on aluminum panels (5×10 cm).

The DLG (Deutsche Landwirtschafts-Gesellshaft) rotary test was used in all cases. Cleaning solutions containing 2% by weight of the respective formulation were produced by dilution of the formulation listed in Table 1 with 16° d water, for carrying out the tests.

The prepared aluminum panels and coated stainless steel test panels were then cleaned at 25° C. for a contact time of 10 minutes in accordance with the DLG rotary test. They were then rinsed for 2 minutes with water and subsequently dried for 2 minutes. 10 cleaning cycles were carried out in this way.

The attack on the test panels was then evaluated visually. The results of the evaluation are compiled in Table 2. The evaluation numbers have the following meanings:
1=no attack in comparison with zero (16° d water)
2=slight, acceptable matting of the surface
3=unacceptable matting of the surface
4=clearly visible attack of the surface
5=pronounced attack of the surface

6=complete destruction of the surface.

TABLE 2
Material compatibility of aqueous cleaning solutions containing 2%
by weight of formulations of different compositions (according to Table 1)
by the DLG rotary test relative to aluminum panels and coated stainless
steel panels

| | Visual evaluation of the examples | | | | | | |
|---|---|---|---|---|---|---|---|
| Material compatibility | Comp. 1 | Comp. 2 | Comp. 3 | Comp. 4 | Ex. 1 | Ex. 2 | Ex. 3 |
| Coated stainless steel | 5 | 3 | 5 | 4 | 2 | 2 | 1 |
| panels | | | | | | | |
| Aluminum panels | 6 | 4 | 6 | 5 | 2 | 2 | 2 |

Comp. 1 to 4 = comparison examples
Ex. 1 to 3 = examples according to the invention

As shown clearly by the material compatibility tests, aluminum surfaces and coated stainless steel surfaces are much less subject to attack by the formulations according to the invention than by formulations from the prior art.

1-15. (canceled)

16. A method of cleaning a vehicle surface comprising applying to the vehicle surface a composition comprising:
i. gluconic acid; and
ii. a complexing agent selected from the group consisting of polyamino acids, polycarboxylic acids, and mixtures thereof.

17. The method of claim 16, wherein the complexing agent is selected from the group consisting of polyaspartic acid, and a copolymer based on aspartic acid.

18. The method of claim 16, wherein the complexing agent is present from about 0.1 to about 75% by weight.

19. The method of claim 16, the composition further comprising a nonionic surfactant.

20. The method of claim 19, wherein the nonionic surfactant is selected from the group consisting of alkoxylated fatty alcohols, alkyl polyglycosides, and alkoxylated fatty amines.

21. The method of claim 16, wherein the composition has a pH from about 4 to about 10.

22. The method of claim 17, wherein the composition comprises from about 0.1 to about 30% by weight of polyaspartic acid.

23. The method of claim 17, wherein the composition comprises from about 0.1 to about 30% by weight of polyaspartic acid, and from about 0.1 to about 50% by weight of gluconic acid.

24. The method of claim 16, wherein the cleaning composition is diluted with water to form a ready-to-use cleaning solution comprising from about 0.025 to about 100 grams per liter of the complexing agent.

25. The method of claim 24, wherein the ready-to-use cleaning solution further comprises from about 0.05 to about 50 grams per liter of a nonionic surfactant.

26. The method of claim 16, further comprising rinsing the cleaning composition of the surface of the vehicle.

27. The method of claim 16, wherein the cleaning the composition is applied to wheel rims.

28. A vehicle cleaning composition comprising:
i. gluconic acid; and
ii. a complexing agent selected from the group consisting of polyamino acids, polycarboxylic acids, and mixtures thereof.

29. The composition of claim 28, wherein the complexing agent is selected from the group consisting of polyaspartic acid, and a copolymer based on aspartic acid.

30. The composition of claim 28, wherein the complexing agent is present from about 0.01 to about 75% by weight.

31. The composition of claim 28, further comprising a nonionic surfactant.

32. The composition of claim 31, wherein the nonionic surfactant is selected from the group consisting of alkoxylated fatty alcohols, alkyl polyglycosides, and alkoxylated fatty amines.

33. The composition of claim 28, wherein the composition has a pH from about 4 to about 10.

34. The composition of claim 29, wherein the composition comprises from about 0.01 to about 30% by weight of polyaspartic acid.

35. The composition of claim 29, wherein the composition comprises from about 0.01 to about 30% by weight of polyaspartic acid, and from about 0.01 to about 50% by weight of gluconic acid.

36. The composition of claim 28, wherein the composition is diluted with water to form a ready-to-use cleaning solution comprising from about 0.025 to about 100 grams per liter of the complexing agent.

37. The composition of claim 36, wherein the ready-to-use cleaning solution further comprises from about 0.05 to about 50 grams per liter of nonionic surfactant.
